(19) United States
(12) Patent Application Publication
(10) Pub. No.: US 2008/0163830 A1
(43) Pub. Date: Jul. 10, 2008

(54) RETRACTABLE LEASH AND RESTRAINT ASSEMBLY

(76) Inventor: Brian Dagnon, Pocatello, ID (US)

Correspondence Address: BELL, BOYD & LLOYD, LLP, P.O. Box 1135, CHICAGO, IL, 60690, US

(21) Appl. No.: 11/619,968

(22) Filed: Jan. 4, 2007

(51) Int. Cl. A01K 27/00

(52) U.S. Cl. 119/794

(57) ABSTRACT

The present invention provides a retractable leash and animal restraint assembly. The assembly includes pet collar and a leash. Integral to the pet collar is a cavity and a length of a collar interior, enclosing a leash. A housing may enclose at least a portion of the leash within the cavity. The leash may be extracted from and retracted into the collar by force exerted on a handle at one end of the leash. In another embodiment, a pet harness is disclosed, also having a leash integral to the harness.

### BACKGROUND OF THE INVENTION

The present invention relates generally to a retractable leash and animal restraint assembly. More particularly, the present invention relates to a retractable leash and collar assembly.

Conventional animal restraining assemblies comprise collars and separate, detachable leashes. Oftentimes these assemblies consist of multiple parts that must be assembled prior to use. This can become quite cumbersome when a user is attempting to walk his or her pet and must carry the additional parts, such as the leash, in case necessary. Particularly in cases where a user chooses to utilize such assemblies during exercise, any additional components may make the practice altogether distasteful.

Even where integrated restraining devices exist, these devices are traditionally uncomfortable for the animal and cumbersome for the user, as they traditionally comprise bulky, heavy components. For example, instead of a user needing to carry the additional apparatus, as described above, the animal is forced to bear the burden. Even where integrated assemblies exist, such devices traditionally lack the strength to fully restrain a large animal, as well as the flexibility to enable a user to easily extract and retract the leash from the restraining component. Further, traditionally even the integrated assemblies require separate pouches or components as part of the assembly, making manufacture of the device unnecessarily expensive.

A need therefore exists for a retractable leash and restraint assembly having a collar comprising a built-in leash that is not exposed to the elements, which minimizes excess equipment, is comfortable to the animal, is easy to use and to assemble, and that is strong enough to restrain even larger-weight animals.

### SUMMARY OF THE INVENTION

The present invention provides a retractable leash and animal restraint assembly.

In an embodiment, the assembly includes a pet collar and a leash. A portion of the collar comprises an interior including a cavity and having an aperture. A leash housing is present within the cavity of the collar. The leash extends out of the leash housing, into the collar interior and out of the aperture. The leash terminates in a handle which partially extends through the aperture.

In an embodiment, the leash can be extracted from and retracted into the pet collar.

In an embodiment, the leash can be extracted from the pet collar by a force generated on the leash handle.

In another embodiment, the leash is retracted into the pet collar by a recoil mechanism comprising an inwardly biased coiled spring housed within the leash housing, the spring being affixed to an end of the leash for mechanically retracting the leash.

In an embodiment, the recoil mechanism is not exposed to the elements.

In an embodiment, the retractable leash and animal restraint assembly is lightweight enough to be positioned anywhere around the animal's head.

In an embodiment, the pet collar is made of nylon.

In an embodiment, the pet collar is adjustable.

In another embodiment, the pet collar contains an accessory ring.

In an embodiment, the pet collar is a dog collar.

In an embodiment, the leash assembly includes a pet harness and a leash within a leash housing. The leash housing is located in a cavity within the interior of the pet harness. The leash extends out of the leash housing, into a portion of the interior having an opening, and terminates in a handle which partially extends through the opening.

Additional features and advantages of the present invention are described in, and will be apparent from, the following Detailed Description of the Invention and the figures.

### BRIEF DESCRIPTION OF THE FIGURES

FIG. 1 is a perspective view a retractable leash assembly in accordance with the present invention.

FIG. 2 is a cutaway sectional view of the retractable leash assembly of FIG. 1 illustrating the inner components of the embodiment of FIG. 1.

FIG. 3 is a side perspective view of the retractable leash assembly of FIG. 1.

FIG. 4 is a top perspective partial view of another embodiment of a retractable leash assembly in accordance with the present invention.

### DETAILED DESCRIPTION OF THE INVENTION

Referring to the Figures generally, a retractable leash assembly is shown.

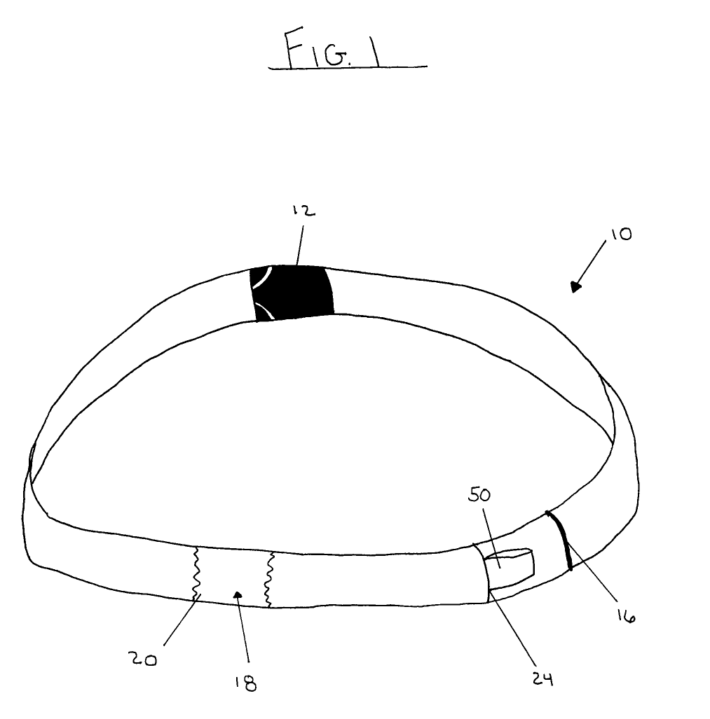

As shown in the embodiment of FIG. 1, the present invention includes a pet collar 10. The pet collar 10 of the embodiment is generally of a given width. The collar 10 may be of any known material, including nylon, cotton, or the like. The pet collar 10 may be utilized for any type of pet, including but not limited to dogs, cats, ferrets, and the like.

The pet collar 10 of FIG. 1 illustrates a dog collar. The collar 10 includes a fastener 12 for easy attachment to and removal from a dog. It will be appreciated that any type of fastener may be utilized, particularly a snap-type fastener such as that shown in FIG. 1. Other fasteners may include hook and loop, snap, button and tie-type fasteners (not shown).

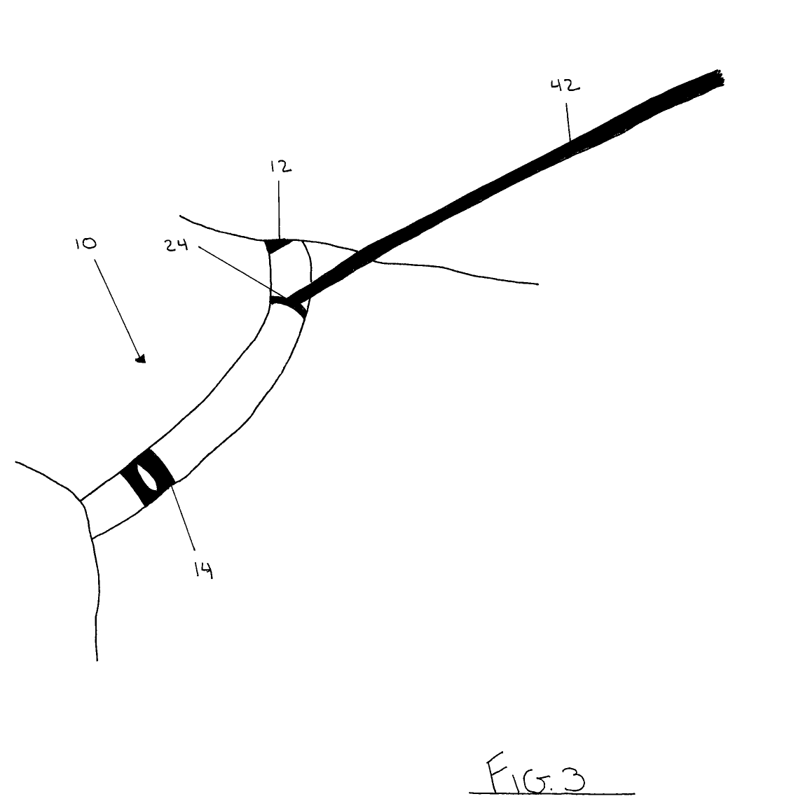

Collar 10 of the Figures may be adjustable to provide a secure fit to the animal. As shown in FIG. 3, this feature may be provided by a typical cinch-type 14 adjustment system. The cinch 14 of FIG. 3 allows the collar 10 to be tightened or loosened around the neck of the animal by sliding the cinch around the length of the collar 10. In another embodiment (not shown) the collar 10 is made to a predetermined size.

It will be appreciated that the collar 10 of the present invention may additionally include any number of accessories found useful for such a device. For example, an accessory ring 16 may be present. The accessory ring 16 is useful for any number of purposes including allowing attachment of a second leash, providing for attachment of dog tags or other identification for the animal, or the like.

As noted above, the collar 10 of the present invention is generally of a given width, however, also present is interior 18 including a cavity 20 and having an aperture 24. The cavity 20 is integral to the collar 10 and may be of a width substantially greater than the remainder of the collar. Cavity 20 is an extension of interior 18, and is integral to the collar 10. The cavity 20 houses the leash. Optionally present is a housing 40, serving as an integrated receptacle for carrying a leash 42.

Adjacent cavity 20 is interior 18, and adjacent interior 18 is aperture 24. Aperture 24 allows leash 42 to travel into and out of the collar 10. It will be appreciated that aperture 24 may be reinforced by any means including presence of an eyelet (not shown) or other suitable reinforcement apparatus.

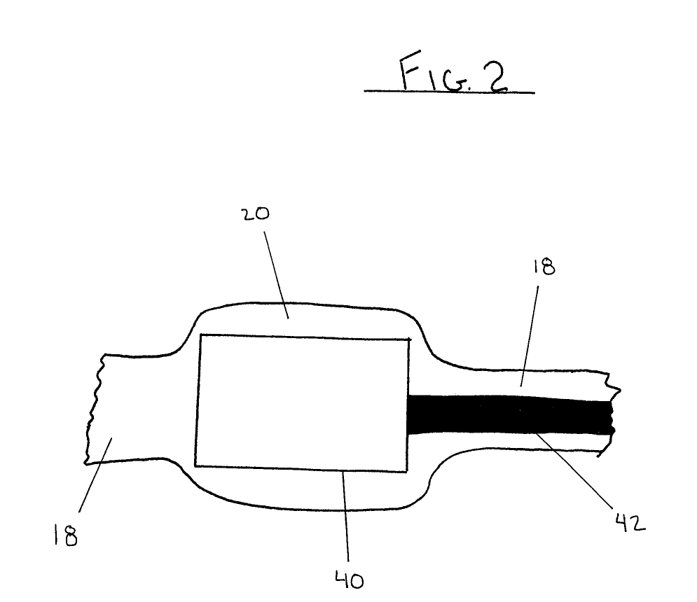

As illustrated by the embodiment of FIG. 2, within the cavity 20 optionally resides a leash housing 40. The leash housing 40 is enclosed by the collar 10 and may be of any known material. In the embodiment shown, the housing 40 is made of a lightweight but sturdy plastic material such as polyethylene terephthalate. In an embodiment, the housing 40 may be of metal material. In an embodiment the housing 40 may be or Cordura® or similar fabric. The housing 40 lodges the leash 42 when it is in a retracted position, as well as the mechanism for retracting the leash 42 (discussed below). Additionally, the housing 40 provides protection of the leash 42 when it is not in use.

The leash 42 may be of any known material. In an embodiment of the present invention, the leash 42 is made of nylon. In an embodiment, the leash 42 is made of a steel cable. One end of the leash 42 is fixedly attached to the collar 10. As shown in FIG. 2 (and as discussed below), this end of the leash 42 may be attached to a coiled spring, to aid in the extraction and retraction of the leash from the collar 10. The leash 42 may be of any conventional length. In an embodiment, the leash is at least eight feet in length. In an embodiment, the leash is not longer than twelve feet in length. In yet another embodiment, the leash 42 is between three feet and six feet in length.

The opposite end of the leash is fixedly attached to a handle 50. The handle 50 may be of any known material, and in the embodiment shown is of the same material as the collar 10. The handle 50 may take any generally known shape and form as will be appreciated in the art. As shown in FIG. 1, the handle 50 is sufficiently flexible so as to travel through aperture 24, at least partially.

Within the cavity 20 is the mechanism by which the leash 42 is retracted into the collar 10. FIG. 2 demonstrates an embodiment whereby the cavity 20 additionally contains a housing 40, though the housing 40 is optional. More particularly, as shown in FIG. 2, the housing 40 lodges an inwardly biased coiled spring 44. The spring 44 is affixed to one end of the leash 42, for mechanically retracting the leash. When the leash 42 is extended for use, as shown in FIG. 3, the coiled spring 44 expands, generating pressure on the leash 42. When the leash 42 is released, the spring 44 retracts the leash 42 into the housing 40 (not shown in FIG. 3). In an embodiment, the leash 42 is retracted almost entirely into the collar. In another embodiment, the recoil mechanism is enclosed in webbing, maintaining the leash 42 in a covered state until manually retrieved from the collar.

Optionally, additionally present is a locking mechanism. In an embodiment, the locking mechanism allows the user to pull the leash 42 out of the collar and lock the leash at a given length so as to prevent the leash 42 from retracting back into the collar 10, unless desired. The locking mechanism may be of any suitable construction. In an embodiment, the locking mechanism comprises a buckle engagement clip (not shown). In another embodiment, the locking mechanism comprises a catch and release toggle (not shown). In this embodiment, the locking mechanism has a release toggle capable of remaining in different positions. In one position, the toggle is flush with the end of lock, and cannot move. In an embodiment, release toggle is spring loaded so that it always returns to the unlocked position.

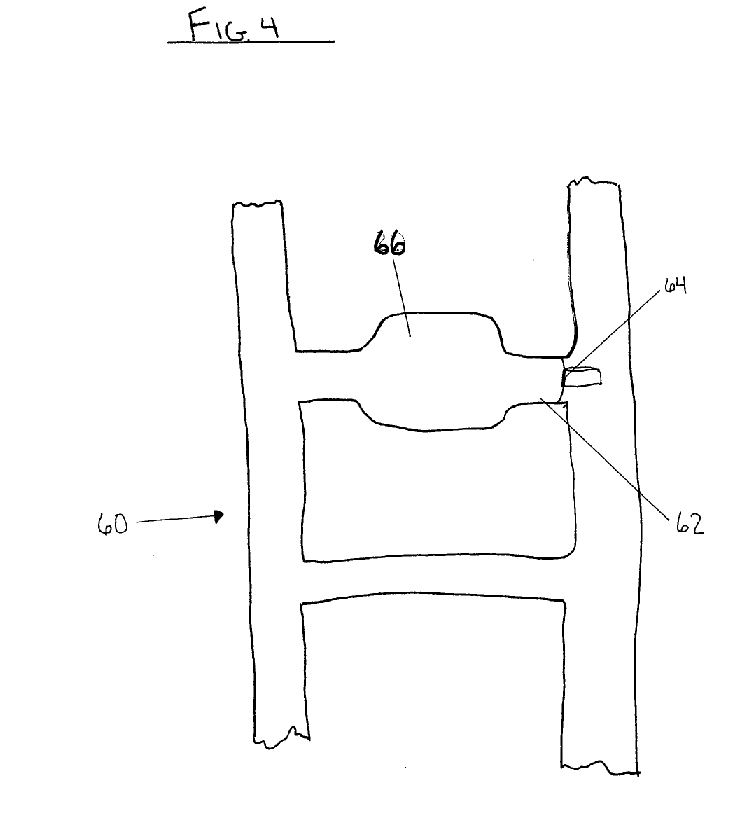

In another embodiment, as illustrated in FIG. 4, the assembly comprises a harness 60 as the restraining device. As with the collar 10, described above, the harness 60 comprises an interior 62 having an aperture 64 and including a cavity 66. Although the cavity 66 shown in FIG. 4 is notably wider than the remainder of the harness 60, this is an optional feature of the device. The harness may be made of any suitable material, in an embodiment the material being nylon.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A retractable leash and animal restraint assembly comprising:
a pet collar comprising a band of material of a given width, a portion of which defines a collar interior, and an aperture, the band defining a cavity; and
a retractable leash comprising a handle;
wherein said leash is enclosed by the cavity and is fed through the collar interior.

2. The assembly of claim 1 wherein the pet collar is a dog collar.

3. The assembly of claim 1 wherein the pet collar is adjustable.

4. The assembly of claim 1 wherein the pet collar material is nylon.

5. The assembly of claim 1 wherein the leash is withdrawn from the cavity by a force generated on the leash handle.

6. The assembly of claim 5 further comprising an inwardly biased coiled spring, the spring being affixed to an end of the leash for mechanically retracting the leash.

7. The leash assembly of claim 1 further comprising a locking mechanism for locking and unlocking the leash in a retracted position.

8. A retractable leash and animal restraint assembly comprising:
multiple bands of material of a given width which define an interior and an aperture, the band defining a cavity; and
a retractable leash comprising a handle;
wherein said leash is enclosed by the cavity and is fed through the collar interior.

9. The assembly of claim 8 whereby the animal restraint assembly comprises a pet harness.

10. The assembly of claim 8 wherein the harness is adjustable.

11. The assembly of claim 8 wherein the harness material is nylon.

12. The assembly of claim 8 wherein the leash is withdrawn from the interior by a force generated on the leash handle.

13. The assembly of claim 12 further comprising an inwardly biased coiled spring, the spring being affixed to an end of the leash for mechanically retracting the leash.

14. A retractable leash and animal restraint assembly comprising:
a pet collar comprising a band of material of a given width, a portion of which defines a collar interior, and an aperture, the band defining a cavity; and
a retractable leash comprising a handle;
an inwardly biased coiled spring housed within the leash housing, the spring being affixed to an end of the leash for mechanically retracting the leash.
wherein said leash is enclosed by the cavity and is fed through the collar interior.

15. The assembly of claim 14 wherein said inwardly biased coiled spring expands when said leash is extended for use, and said spring contracts when said leash is released.

16. The assembly of claim 14 wherein the leash is withdrawn from the collar interior by a force generated on the leash handle.

17. The assembly of claim 14 further comprising a locking mechanism for locking and unlocking the leash in a retracted position.

18. The assembly of claim 14 further comprising an accessory ring.

19. The assembly of claim 14 wherein the collar is adjustable.

20. The assembly of claim 14 wherein the leash handle is of the same material as the collar.
